(19) United States
(12) Patent Application Publication
(10) Pub. No.: US 2026/0023968 A1
(43) Pub. Date: Jan. 22, 2026

(54) TRANSLATION MODEL TRAINING METHOD, MEDIUM, COMPUTER DEVICE AND PROGRAM PRODUCT

(71) Applicant: Hangzhou Alibaba International Internet Industry Co., Ltd., Hangzhou (CN)

(72) Inventors: Huangyu DAI, Hangzhou (CN); Ben CHEN, Hangzhou (CN); Kaidi CHEN, Hangzhou (CN); Wen JIANG, Hangzhou (CN)

(21) Appl. No.: 19/252,466

(22) Filed: Jun. 27, 2025

(30) Foreign Application Priority Data
Jun. 28, 2024 (CN) 202410872811.4

(51) Int. Cl. G06N 3/08; G06N 3/0455; G06Q 30/0601

(52) U.S. Cl. CPC G06N 3/08; G06N 3/0455; G06Q 30/0623

(57) ABSTRACT

A translation model training method comprises: acquiring a first translation loss, which is positively correlated with a probability that a target output token and a preceding output token are the same token, the target output token being the token expected to be output when translating a plurality of input tokens included in input information, and the preceding output token being the token obtained by the translation model when translating the plurality of input tokens before obtaining the target output token; acquiring a first contribution degree of the plurality of input tokens to the target output token and a second contribution degree of the plurality of input tokens to the preceding output token; adjusting the first translation loss based on a similarity between the first contribution degree and the second contribution degree to obtain a second translation loss; and training the translation model based on the second translation loss.

### CROSS-REFERENCE TO RELATED APPLICATIONS

This application claims priority to Chinese Patent Application No. 202410872811.4, filed with the China National Intellectual Property Administration on Jun. 28, 2024, and entitled “Translation Model Training Method, Medium, Computer Device and Program Product,” which is incorporated herein by reference in its entirety.

### TECHNICAL FIELD

The present disclosure relates to the field of artificial intelligence technology, and in particular, to a training method, medium, computer device, and program product for a translation model.

### BACKGROUND

When using a translation model to translate information from one language into another, the issue of translation hallucination may arise. Translation hallucination refers to the occurrence of repetitive content in the translation results. This issue can reduce the quality and efficiency of translation, thereby negatively impacting user experience. To mitigate translation hallucination, existing techniques aim to train the translation model to minimize the probability of generating repetitive content. However, repetitive content is not always caused by translation hallucination; it may also stem from the input information itself containing repetitions. Translation models trained using existing techniques struggle to distinguish between these two scenarios. As a result, repetitive content inherent in the input information may be mistakenly identified as translation hallucination and excluded from the output, leading to a decline in translation quality.

### SUMMARY

In a first aspect, an embodiment of the present disclosure provides a training method for a translation model, including: acquiring a first translation loss of the translation model, wherein the first translation loss is positively correlated with a probability that a target output token and a preceding output token of the translation model are the same token, the target output token being the token expected to be output by the translation model when translating a plurality of input tokens included in input information, and the preceding output token being the token obtained by the translation model when translating the plurality of input tokens before obtaining the target output token; acquiring a first contribution degree of the plurality of input tokens to the target output token and a second contribution degree of the plurality of input tokens to the preceding output token; adjusting the first translation loss based on a similarity between the first contribution degree and the second contribution degree to obtain a second translation loss of the translation model; and training the translation model based on the second translation loss.

In a second aspect, an embodiment of the present disclosure provides a translation method for product information, including: acquiring target product information from an e-commerce platform; acquiring translated product information obtained by translating the target product information using a translation model, wherein the translated product information and the target product information are in different languages; and wherein the translation model is trained using the method described in any embodiment of the present disclosure.

In a third aspect, an embodiment of the present disclosure provides a computer-readable storage medium storing a computer program, wherein the program, when executed by a processor, implements the method described in any embodiment of the present disclosure.

In a fourth aspect, an embodiment of the present disclosure provides a computer device, including a memory, a processor, and a computer program stored in the memory and executable by the processor, wherein the processor, when executing the program, implements the method described in any embodiment of the present disclosure.

In a fifth aspect, an embodiment of the present disclosure provides a computer program product, including a computer program, wherein the computer program, when executed by a processor, implements the method described in any embodiment of the present disclosure.

The inventors have discovered that in the absence of translation hallucination, the contribution degrees of a plurality of input tokens in the input information to different output tokens are distinct. However, in the presence of translation hallucination, the contribution degrees of a plurality of input tokens in the input information to different output tokens tend to be more similar. Therefore, in the embodiments of the present disclosure, after obtaining the first translation loss of the translation model, the first contribution degree of the plurality of input tokens to the target output token and the second contribution degree of the plurality of input tokens to the preceding output token are further acquired. The first translation loss is then adjusted to a second translation loss based on the similarity between the first contribution degree and the second contribution degree, and the translation model is trained based on the second translation loss. The similarity between the first contribution degree and the second contribution degree reflects the probability of translation hallucination. Thus, the translation model trained using the aforementioned approach can adjust the suppression intensity of repetitive content based on the probability of translation hallucination, thereby reducing misjudgments of translation hallucination and improving translation quality.

It should be understood that the above general description and the detailed description provided hereinafter are merely exemplary and explanatory, and are not intended to limit the scope of the present disclosure.

### BRIEF DESCRIPTION OF THE DRAWINGS

The accompanying drawings, which are incorporated into and constitute a part of this specification, illustrate embodiments consistent with the present disclosure and, together with the description, serve to explain the technical solutions of the present disclosure.

FIG. 1 is a schematic diagram of an application scenario according to an embodiment of the present disclosure.

FIGS. 2A and 2B are comparative schematic diagrams illustrating the contributions of input tokens to output tokens in the absence and presence of translation hallucination, respectively, according to an embodiment of the present disclosure.

FIG. 3 is a projection diagram of vectors corresponding to output tokens on a two-dimensional plane in the presence of translation hallucination according to an embodiment of the present disclosure.

FIG. 4 is a flowchart of a training method for a translation model according to an embodiment of the present disclosure.

FIG. 5 is a schematic diagram of a process for acquiring the similarity between the first contribution degree and the second contribution degree according to an embodiment of the present disclosure.

FIG. 6 is a schematic diagram of a translation method for product information according to an embodiment of the present disclosure.

FIG. 7 is a schematic diagram of a computer device according to an embodiment of the present disclosure.

### DETAIL DESCRIPTION OF THE EMBODIMENTS

The exemplary embodiments will be described in detail, with examples illustrated in the accompanying drawings. When the following description refers to the drawings, unless otherwise indicated, the same numbers in different drawings represent the same or similar elements. The implementations described in the following exemplary embodiments do not represent all implementations consistent with the present disclosure. Instead, they are merely examples of devices and methods consistent with some aspects of the present disclosure as detailed in the appended claims.

The terms used in the present disclosure are for the purpose of describing specific embodiments only and are not intended to limit the scope of the present disclosure. The singular forms “a,” “the,” and “said” used in the present disclosure and the appended claims are also intended to include plural forms unless the context clearly indicates otherwise. It should also be understood that the term “and/or” as used herein refers to and encompasses any or all possible combinations of one or more associated listed items. Additionally, the term “at least one” as used herein indicates any one of a plurality or any combination of at least two of a plurality.

It should be understood that although terms such as “first,” “second,” “third,” etc., may be used in the present disclosure to describe various information, such information should not be limited by these terms. These terms are only used to distinguish information of the same type from one another. For example, without departing from the scope of the present disclosure, “first information” may also be referred to as “second information,” and similarly, “second information” may also be referred to as “first information.” Depending on the context, the word “if”' as used herein may be interpreted as “when,” “while,” or “in response to determining.”

In order to enable those skilled in the art to better understand the technical solutions in the embodiments of the present disclosure and to make the above objectives, features, and advantages of the embodiments of the present disclosure more apparent and comprehensible, the technical solutions in the embodiments of the present disclosure will be further described in detail below in conjunction with the accompanying drawings.

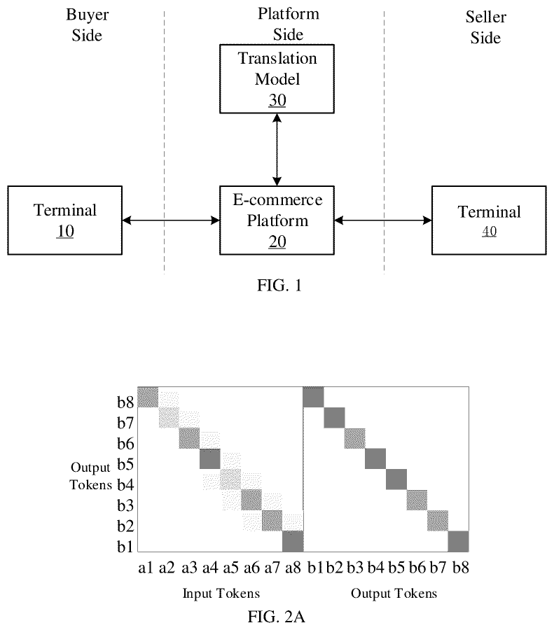

Currently, translation models are widely used across various industries. By employing a translation model, information in one language (hereinafter referred to as “input information”) can be quickly translated into information in another language (hereinafter referred to as “output information”). FIG. 1 exemplarily illustrates a schematic diagram of an e-commerce scenario. As shown in FIG. 1, in the e-commerce scenario, a buyer can access the e-commerce platform 20 through a terminal 10 and interact with the e-commerce platform 20. For example, the e-commerce platform 20 can push product information from the platform to the terminal 10 for display. In practical applications, buyers of the e-commerce platform 20 may come from different countries or regions and use different languages. Therefore, a translation model 30 can be pre-deployed to translate the product information on the e-commerce platform 20 into the target language used by the buyer, and then push the translated product information to the buyer's terminal 10. The translation model 30 can be deployed on the e-commerce platform 20 or independently of the e-commerce platform 20. For another example, when a buyer of the e-commerce platform 20 communicates with a seller of the e-commerce platform 20, the buyer and the seller may use different languages. The information input by the buyer on the terminal 10 can be sent to the e-commerce platform 20, which calls the translation model to translate the information and then forwards the translated information to the seller's terminal 40 for display; alternatively, the information input by the seller through the terminal 40 can be sent to the e-commerce platform 20, which calls the translation model to translate the information and then forwards the translated information to the buyer's terminal 10.

It should be understood that the above application scenario is merely illustrative and is not intended to limit the scope of the present disclosure. In addition to e-commerce scenarios, the translation model 30 in the embodiments of the present disclosure can also be applied to other scenarios. For example, in a news reading platform, the translation model 30 can be used to translate news articles published on the platform; in a video streaming platform, the translation model 30 can be used to translate subtitles in videos; and so on. For the sake of clarity, the following description primarily uses the e-commerce scenario illustrated in FIG. 1 as an example to explain the solutions of the embodiments of the present disclosure.

The translation model 30 may encounter the issue of translation hallucination during the translation process, which refers to the occurrence of repetitive content in the translation results. In a specific example, assume the input information is in English and the output information is in German. When the input information is “1.8 Ton Mini Excavator Crawler Excavator Mini Bagger Cheap Price With Ce For Sale Epa Ce Mini Excavator,” under normal circumstances, if there is no translation hallucination, the output information should be “1,8 Tonnen Mini Bagger Mini Bagger Preis mit Ce Zum Verkauf Epa Ce Mini Bagger.” However, in the presence of translation hallucination, the output information might resemble “1,8 Tonnen Mini Bagger Bagger Bagger Bagger Bagger . . . ”. As can be seen, when translation hallucination occurs, the output information of the translation model 30 includes a plurality of repetitions of “Bagger.”

To mitigate the issue of translation hallucination, existing techniques aim to train the translation model 30 by minimizing the probability of generating repetitive content in its output. However, repetitive content is not always caused by translation hallucination; it may also result from the input information itself containing repetitions. For example, in e-commerce scenarios, the input information for the translation model 30 often includes product titles. Product titles typically do not follow the grammatical rules of normal conversation and instead accumulate nouns and adjectives. For instance, a product title might be “4-in-1 Modern Rotating Multi-functional Billiards Table 7 Feet with Air Hockey Table 4-in-1 Game Table.” In this product title, “4-in-1” and “Table” appear a plurality of times, and the output information translated by the translation model 30 should accordingly include translations corresponding to the plurality of occurrences of “4-in-1” and “Table.” However, since the translation model 30 is trained with the goal of minimizing repetitive output, it tends to suppress repetitive content in the output information even when such repetitions are inherent in the input. This suppression can lead to a degradation in translation quality.

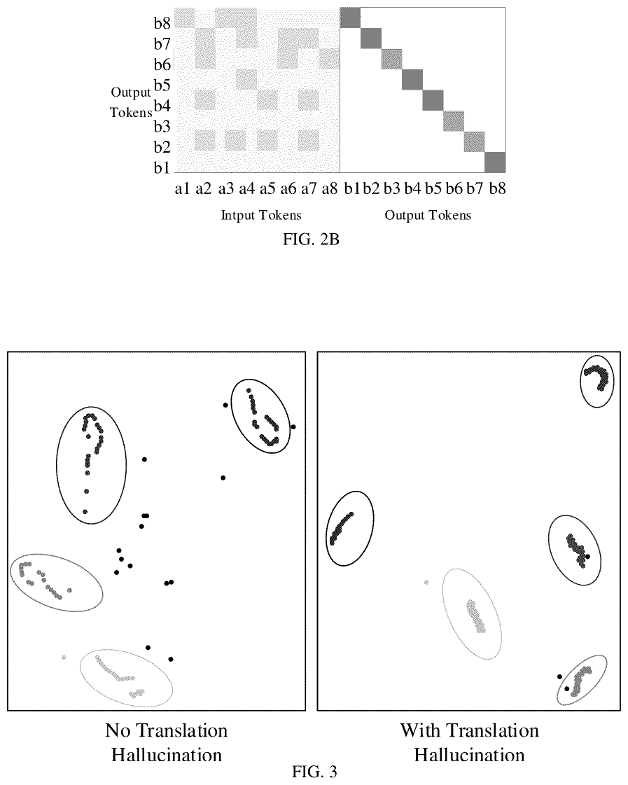

The inventor found that, in general, the contribution of a plurality of input tokens to different output tokens in input information is different, meaning that different output tokens are usually translated from different input tokens. For example, suppose the input information is in English, “I like red dress,” and the output information is in Chinese, “ [symbol] .” If each English word is an input token and each Chinese character is an output token, the output token “ [symbol] ” is translated from the input token “I,” so the input token “I” has the highest contribution to the output token “ [symbol] ” (“I”), while other input tokens in the input information have much lower contribution to the output token “ [symbol] ” (“I”). Similarly, the output token “ [symbol] ” (“like”) is translated from the input token “like,” so the other input tokens in the input information contribute much less to the output token “ [symbol] ” (“like”) than the input token “like.” Therefore, for any two output tokens, the contribution of each input token to these two output tokens is usually different. The similarity of the contributions of input tokens to different output tokens can reflect the probability of translation hallucination occurring. FIG. 2A and 2B show examples of the contribution of each input token to the output token in cases where there is no translation hallucination problem and where there is a translation hallucination problem. In FIG. 2A and 2B, a1 to a8 represent the input tokens, b1 to b8 represent the output tokens, and the box in row i, column j represents the contribution of input token j to output token i. The depth of the box is positively correlated with the size of the contribution it represents. As shown in FIG. 2A, when there is no translation hallucination problem, the input token with the highest contribution to each output token is usually different, showing a one-to-one correspondence between the input and output tokens. However, in the case of a translation hallucination problem, the contributions of input tokens to output tokens are more chaotic and disordered, and there may be cases where a plurality of input tokens have similar contributions to different output tokens.

FIG. 3 illustrates the projection of vectors corresponding to input tokens on a two-dimensional plane, where each dot represents an output token, and dots within the same ellipse represent identical output tokens. From FIG. 3, it can be observed that when translation hallucination occurs, the translation model 30 repeatedly generates a plurality of identical output tokens. Moreover, it is evident that the translation information on the right side of FIG. 3 exhibits a more severe translation hallucination issue compared to the translation information on the left side. On the right side, the translation model 30 generates almost entirely repetitive output tokens.

Therefore, the training objective of the translation model 30 can be optimized by leveraging the similarity between the contribution degrees of a plurality of input tokens to different output tokens. This enables the translation model 30 to adjust the suppression intensity of repetitive content based on the probability of translation hallucination, thereby reducing misjudgments of translation hallucination by the translation model 30. Additionally, optimizing the translation model 30 during the training phase, as opposed to the inference phase, can effectively save inference time and improve translation efficiency without increasing inference costs. Below, specific solutions of the embodiments of the present disclosure are illustrated with examples.

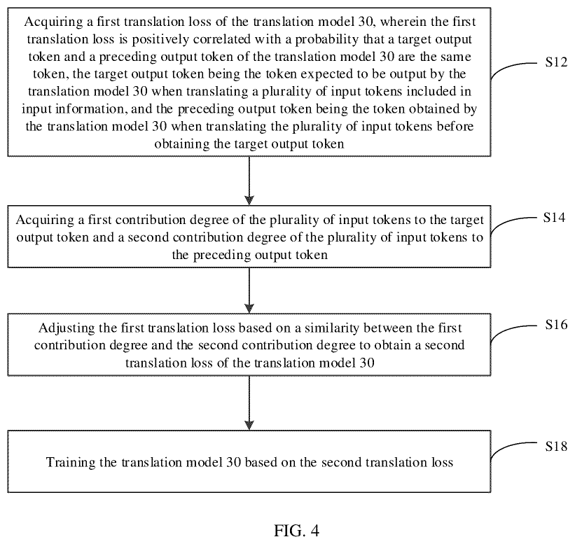

Referring to FIG. 4, based on this, an embodiment of the present disclosure provides a training method for the translation model 30. The method includes:
S12: acquiring a first translation loss of the translation model 30, wherein the first translation loss is positively correlated with a probability that a target output token and a preceding output token of the translation model 30 are the same token, the target output token being the token expected to be output by the translation model 30 when translating a plurality of input tokens included in input information, and the preceding output token being the token obtained by the translation model 30 when translating the plurality of input tokens before obtaining the target output token;
S14: acquiring a first contribution degree of the plurality of input tokens to the target output token and a second contribution degree of the plurality of input tokens to the preceding output token;
S16: adjusting the first translation loss based on a similarity between the first contribution degree and the second contribution degree to obtain a second translation loss of the translation model 30;
S18: training the translation model 30 based on the second translation loss.

In S12, the input information can be fed into the translation model 30, which translates the input information to generate output information. The input information and output information can be in any language. For example, the input information may be in English and the output information in German; or the input information may be in French and the output information in Chinese; or the input information may be in Chinese and the output information in German; and so on. The input information can be textual or in other modalities, such as images or audio. When the input information is an image, Optical Character Recognition (OCR) can be used to extract textual information from the image, which is then translated. When the input information is audio, speech recognition can be used to extract textual information from the audio, which is then translated. OCR and speech recognition can be implemented using models or methods independent of the translation model 30, or these functionalities can be integrated directly into the translation model 30.

The input information may include a plurality of input tokens, where a token is the basic unit for translation by the translation model 30. A token can be a character, a word, a phrase, or even a part of a character or word. For example, in Chinese, the radical and non-radical parts of a single character can be treated as separate tokens. Similarly, in English, the root and affixes of a single word can be treated as different tokens. A pre-trained token extraction model can be used to extract and identify the plurality of input tokens from the input information. The output information may also include a plurality of output tokens, and the method for determining output tokens is similar to that for input tokens, which will not be repeated here.

During the translation process, the translation model 30 can sequentially obtain a plurality of output tokens. Each token that the translation model 30 expects to output at a given step is referred to as the target output token. When generating the target output token, the translation model 30 can refer to the preceding output token(s) of the target output token. The preceding output token(s) are the output token(s) obtained by the translation model 30 before generating the target output token when translating the plurality of input tokens. For example, when the translation model 30 translates a plurality of input tokens, it first generates the 1st output token, which is then the target output token. Next, the translation model 30 can use the 1st output token as contextual information to continue translating the plurality of input tokens and generate the 2nd output token. At this point, the 2nd output token is the target output token, and the 1st output token is the preceding output token of the target output token. Similarly, the translation model 30 can continue translating the plurality of input tokens based on the 2nd output token, or both the 1st and 2nd output tokens, to generate the 3rd output token. At this stage, the 3rd output token is the target output token, and the 1st and 2nd output tokens are both preceding output tokens of the target output token.

In some embodiments, the distance between the preceding output token(s) and the target output token is less than or equal to a preset distance threshold. In other words, in these embodiments, when determining the second translation loss of the translation model 30, only the preceding output token(s) that are relatively close to the target output token are considered. This is because the dependency between the target output token and its preceding output token(s) typically diminishes as the distance between them increases. By restricting the distance between the target output token and its preceding output token(s), the translation model 30 can better capture local dependencies between tokens, while also reducing the computational load during the training process.

The first translation loss of the translation model 30 is positively correlated with the probability that the target output token and its preceding output token are the same token. In some embodiments, when generating the target output token, the translation model 30 calculates the probabilities of selecting each of a plurality of candidate output tokens as the target output token and determines the candidate output token with the highest probability as the target output token. Among these candidate output tokens, the preceding output token(s) of the target output token may be included. If the probability calculated by the translation model 30 for selecting the preceding output token as the target output token is the highest, then the target output token and its preceding output token are the same token. Therefore, the first translation loss of the translation model 30 can be determined based on the first probability of the translation model 30 selecting the preceding output token as the target output token. The first translation loss determined in this way effectively minimizes the probability of the translation model 30 generating output information that includes identical output tokens.

Furthermore, in addition to the input information, the input to the translation model 30 can also include reference translation information corresponding to the input information. The reference translation information can be obtained by manually translating the input information, or by using another translation model with superior performance compared to the translation model 30 as a teacher model, and then determining the output information generated by the teacher model as the reference translation information. The reference translation information may include a plurality of translation tokens, and it is in the same language as the output information generated by the translation model 30. Since the reference translation information is obtained through manual translation or by using a translation model with better performance than the translation model 30, its accuracy and reliability are higher. Thus, the reference translation information can be used as the ground truth for the output information generated by the translation model 30. When the target output token generated by the translation model 30 is the i-th output token in the output information, the translation token at the corresponding position in the reference translation information (i.e., the i-th translation token in the reference translation information, hereafter referred to as the target translation token) serves as the ground truth for the target output token. When the translation model 30 generates output information based on the reference translation information, the first translation loss of the translation model 30 is also inversely correlated with the consistency between the target output token and the target translation token. The first translation loss of the translation model 30 can be determined based on the first probability of the translation model 30 selecting the preceding output token as the target output token and the second probability of the translation model 30 selecting the target translation token as the target output token. This approach ensures that the output information generated by the translation model 30 aligns as closely as possible with the reference translation information, thereby improving the translation accuracy of the translation model 30.

In some embodiments, the first translation loss of the translation model 30 can be determined based on the difference between the first probability and the second probability. The first translation loss L0 can be expressed as:

$$L 0 = exp ( {h}_{t}^{T} {W}_{{y}_{t}^{-}} - {h}_{t}^{T} {W}_{{y}_{t}} )$$

where hₜ represents the hidden layer state at the current time step (the moment when the target output token is generated), W_{y}_{_{t̅}} denotes the weight vector in the weight matrix of the translation model 30 corresponding to the preceding output token, W_{y}_{ₜ} denotes the weight vector in the weight matrix of the translation model 30 corresponding to the target output token; T represents matrix transposition operation.

In other embodiments, the first translation loss of the translation model 30 can be directly determined as the difference between the first probability and the second probability. Additionally, other methods based on the first probability and the second probability can be employed to determine the first translation loss of the translation model 30 according to practical requirements. These alternative approaches are not exhaustively listed here.

In S14, the first contribution degree of the plurality of input tokens to the target output token and the second contribution degree of the plurality of input tokens to the preceding output token of the target output token can be obtained. The contribution degree of an input token to an output token characterizes the role of the input token in generating the output token. The higher the contribution degree of an input token to an output token, the greater the role the input token plays in generating the output token, indicating that the output token is primarily translated from that input token. Typically, different output tokens are translated from different input tokens. Therefore, when there is no translation hallucination issue, the first contribution degree of the plurality of input tokens to the target output token and the second contribution degree of the plurality of input tokens to the preceding output token are usually different.

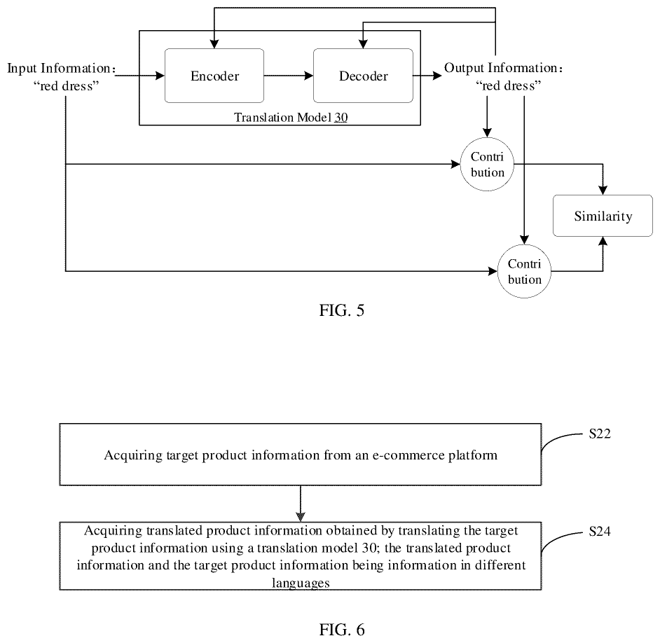

In S16, the first translation loss can be adjusted based on the similarity between the first contribution degree and the second contribution degree to obtain the second translation loss of the translation model 30. As shown in FIG. 5, the input information is the Chinese phrase “ [symbol] ” (“red dress”), and the output information is the English phrase “red dress.” Assuming each Chinese word is an input token and each English word is an output token, the input tokens include “ [symbol] ” (“red”) and “ [symbol] ” (“dress”), and the output tokens include “red” and “dress.” When the target output token is “dress,” the output token “red” is the preceding output token of the target output token. The contribution degree of the input tokens “ [symbol] ” (“red”) and “ [symbol] ” (“dress”) to the output token “red” (i.e., the first contribution degree) and the contribution degree of the input tokens “ [symbol] ” (“red”) and “ [symbol] ” (“dress”) to the output token “dress” (i.e., the second contribution degree) can be obtained. The similarity between these two contribution degrees is then calculated, and the second translation loss of the translation model 30 is determined based on this similarity.

In some embodiments, the first translation loss can be weighted based on the similarity between the first contribution degree and the second contribution degree to obtain the second translation loss of the translation model 30. These embodiments employ a soft decision mechanism using the similarity between the first and second contribution degrees, adjusting the value of the first translation loss based on the level of similarity to modulate the suppression intensity of repetitive tokens. When the similarity is high, the suppression of repetitive tokens is stronger; when the similarity is low, the suppression of repetitive tokens is weaker. Compared to hard decision mechanisms, which output only a single class prediction result, the soft decision mechanism used in the embodiments of the present disclosure outputs a similarity value that can be any real number between 0 and 1, making it applicable to a wider range of scenarios and offering greater flexibility. Additionally, if a hard decision mechanism were used, a similarity threshold would need to be set, and if the threshold were inaccurately defined, it could lead to lower accuracy in model training results. The soft decision mechanism of the embodiments of the present disclosure avoids the issue of inaccurate model training results caused by improperly set similarity thresholds.

In some embodiments, the similarity between the first contribution degree and the second contribution degree can be determined as follows: determine the first attention matrix based on the first contribution degree, determine the second attention matrix based on the second contribution degree, calculate the similarity between the first attention matrix and the second attention matrix, and define this similarity as the similarity between the first and second contribution degrees. The similarity between the first and second attention matrices can be characterized using the cosine distance between them. This similarity can then be used as the weight for the first translation loss, and the first translation loss can be weighted based on this weight to obtain the second translation loss of the translation model 30. The weight for the first translation loss in some embodiments can be expressed as follows:

$${α}_{s} = \frac{{atten}_{t}^{T} {\_atten}_{t}}{‖ {atten}_{t} \_ ‖ ‖ {atten}_{t} ‖}$$

where atten_{t_} represents the first attention matrix, attenₜ represents the second attention matrix, αₛ denotes the weight corresponding to the first translation loss; T represents matrix transposition operation. This method has relatively low implementation complexity and avoids significantly increasing the complexity and cost of the model training process due to the introduction of similarity calculations between contribution degrees.

It should be understood that the above method for obtaining the second translation loss is merely illustrative. In other embodiments, a penalty term can be generated based on the similarity between the first contribution degree and the second contribution degree, and the second translation loss of the translation model 30 can be obtained by summing the first translation loss and the penalty term. Alternatively, other methods can be employed to determine the second translation loss of the translation model 30, which are not exhaustively listed here. These alternative approaches provide flexibility in optimizing the translation model 30 while maintaining the goal of reducing translation hallucination and improving translation quality.

In some embodiments, in addition to adjusting the first translation loss based on the similarity between the first contribution degree and the second contribution degree, since the target output token is less influenced by preceding output tokens that are far away, the first translation loss can also be adjusted based on the distance between the target output token and its preceding output token. Specifically, the second translation loss obtained by adjusting the first translation loss based on the similarity between the first and second contribution degrees can be used as an intermediate translation loss of the translation model 30. This intermediate translation loss can then be further adjusted based on the distance between the target output token and its preceding output token to obtain the final second translation loss of the translation model 30. This approach reduces the influence of preceding output tokens that are far from the target output token on the translation model 30, allowing the model to better capture local dependencies between nearby output tokens.

For example, the intermediate translation loss can be weighted based on the distance between the target output token and its preceding output token to obtain the second translation loss of the translation model 30. This embodiment employs a soft decision mechanism based on the distance between the target output token and its preceding output token, adjusting the value of the intermediate translation loss according to the magnitude of the distance to modulate the suppression intensity of repetitive tokens. When the distance is large, the suppression of repetitive tokens is stronger; when the distance is small, the suppression of repetitive tokens is weaker. Compared to hard decision mechanisms, this soft decision approach is applicable to a wider range of scenarios, offers greater flexibility, and avoids the issue of reduced training accuracy caused by inaccurately set thresholds. It should be understood that weighting the intermediate translation loss to obtain the second translation loss is only one optional method for determining the second translation loss. In other embodiments, a penalty term can be determined based on the distance, and the sum of the intermediate translation loss and the penalty term can be defined as the second translation loss, or other methods can be used to determine the second translation loss, which are not exhaustively listed here.

In embodiments where the intermediate translation loss is weighted to obtain the second translation loss, an exponential operation can be applied to the distance between the target output token and its preceding output token to determine the weight for the intermediate translation loss. The intermediate translation loss can then be weighted based on this weight to obtain the second translation loss of the translation model 30. The weight for the intermediate translation loss can be expressed as:

$${α}_{d} = e \frac{t\_ - t}{T}$$

where α_{d} represents the weight corresponding to the intermediate translation loss, t denotes the position of the target output token, t_ denotes the position of the preceding output token of the target output token, and T is the temperature coefficient.

In actual translation processes, the number of preceding output tokens for the target output token can be greater than or equal to 1. When the number of preceding output tokens is greater than 1, the first translation loss of the translation model 30 includes the translation losses corresponding to each of the preceding output tokens, and the second contribution degree of the plurality of input tokens to the preceding output tokens includes the contribution degrees of the plurality of input tokens to each of the preceding output tokens. Here, the translation loss corresponding to a preceding output token is positively correlated with the probability of the translation model 30 selecting that preceding output token as the target output token.

For example, when the target output token is the third output token in the output information, the preceding output tokens of the target output token include the first and second output tokens in the output information. Therefore, the first translation loss of the translation model 30 includes the translation loss corresponding to the first output token and the translation loss corresponding to the second output token in the output information. The second contribution degree of the plurality of input tokens to the preceding output tokens includes the contribution degrees of the plurality of input tokens to the first output token and the contribution degrees of the plurality of input tokens to the second output token in the output information.

The second translation loss of the translation model 30 can be obtained by summing the translation losses corresponding to each of the preceding output tokens. The translation loss corresponding to the i-th preceding output token is determined as follows: adjust the translation loss corresponding to the i-th preceding output token based on the similarity between the first contribution degree and the contribution degrees of the plurality of input tokens to the i-th preceding output token, to obtain the translation loss for the i-th preceding output token. Continuing with the previous example, the translation loss corresponding to the first output token in the output information can be adjusted based on the similarity between the first contribution degree and the contribution degrees of the plurality of input tokens to the first output token, yielding the translation loss for the first output token. Similarly, the translation loss corresponding to the second output token in the output information can be adjusted based on the similarity between the first contribution degree and the contribution degrees of the plurality of input tokens to the second output token, yielding the translation loss for the second output token. By summing the translation losses corresponding to the first and second output tokens in the output information, the second translation loss of the translation model 30 can be obtained. In some embodiments, the second translation loss of the translation model 30 can be expressed as:

$${L}_{CTSD}^{t} = log ( 1 + {\sum }_{{y}_{t}^{-} ∈ {S}_{N}^{t}} {α}_{d} {α}_{s} exp ( {h}_{t}^{T} {W}_{{y}_{t}^{-}} - {h}_{t}^{T} {W}_{{y}_{t}} ) )$$

where

$${L}_{CTSD}^{t}$$

denotes the second translation loss of the translation model 30,

$${y}_{t}^{-}$$

represents the preceding output token of the target output token,

$${S}_{N}^{t}$$

denotes the set of proceding output tokens of the target output token, α_{d} represents the weight corresponding to the intermediate translation loss, αₛ represents the weight corresponding to the first translation loss, hₜ denotes the hidden layer state at the current moment (the moment when the target output token is obtained),

$${W}_{{y}_{t}^{-}}$$

denotes the weight vector in the weight matrix of the translation model 30 corresponding to the preceding output token, and W_{y}_{ₜ} denotes the weight vector in the weight matrix of the translation model 30 corresponding to the target output token.

It can be understood that the above formula is just one optional method for calculating the second translation loss of translation model 30. In other examples, alternative methods can also be used to calculate the second translation loss of translation model 30. For instance, the first translation loss may be weighted solely using weight αₛ, without applying weight α_{d} for a secondary weighting of the result after the first weighting by αₛ.

In practical applications, there may be plurality of target output tokens. The second translation loss

$${L}_{CTSD}^{t}$$

corresponding to each target output token for translation model 30 can be determined in the manner described above. The second translation losses

$${L}_{CTSD}^{t}$$

for each of the acquired target output tokens can then be summed to obtain the final translation loss, and the translation model 30 can be trained based on the final translation loss.

In S18, the weights of translation model 30 can be adjusted to minimize the second translation loss of translation model 30 acquired in S6.

It can be understood that, in addition to the second translation loss obtained earlier, the translation model 30 in the present disclosure can also be trained by incorporating a third translation loss. The third translation loss can be set according to actual needs, with no specific limitations herein. In some embodiments, the third translation loss is the Cross-Entropy (CE) loss. The second translation loss and the third translation loss can be weighted to obtain a weighted loss, and the translation model 30 can be trained based on the weighted loss. The weights for combining the second and third translation losses can be set as hyperparameters during the training process of translation model 30. In some embodiments, when determining the second translation loss, only the preceding output tokens that are closer to the target output token may be referenced, while when determining the third translation loss, all output tokens in the output information can be considered.

In the aforementioned embodiments, a plurality of input tokens can be extracted from sample product information, which may be obtained from e-commerce platforms. The sample product information includes at least two identical words. The sample product information may be product titles or product attribute information. Taking product titles as an example, product titles on e-commerce platforms often include repetitive words. For instance, in the product title “4-in-1 Modern Rotating Multifunctional Pool Table 7 Feet with Air Hockey Table 4-in-1 Game Table,” the word “table” is a repetitive word. When translating, the translation model should ideally translate all instances of “table” in the product title. However, if trained using conventional methods, the resulting model might mistakenly perceive the repeated occurrences of “table” as translation hallucinations and suppress them, leading to reduced translation quality. By employing the methods described in the embodiments of the present disclosure, it becomes possible to effectively distinguish between translation hallucinations and inherently repetitive content in the input information, thereby minimizing unnecessary suppression of repetitive content and improving translation quality. The methods of the present disclosure can be integrated into proprietary translation training pipelines, significantly mitigating translation hallucination issues in input information with repetitive content, such as product titles, while also reducing misjudgments of translation hallucinations.

Referring to FIG. 6, the present disclosure also provides a translation method for product information, the method including:
S22: acquiring target product information from an e-commerce platform;
S24: acquiring translated product information obtained by translating the target product information using a translation model 30; the translated product information and the target product information being information in different languages;
wherein, the translation model 30 is trained based on the method described in any embodiment of the present disclosure.

The translation method in this embodiment can be used to translate the target product information from an e-commerce platform to obtain high-quality translation results. The target product information can be the product title or the attribute information of the product. The training process of translation model 30 can be referred to from the previous embodiments and will not be repeated here.

The present embodiment also provides a computer device, which includes at least a memory, a processor, and a computer program stored on the memory and executable by the processor, wherein the processor executes the program to implement the method described in any of the embodiments above.

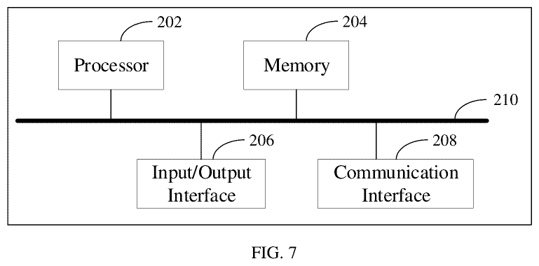

FIG. 7 illustrates a schematic diagram of a more specific hardware structure of the computer device provided by the present disclosure. The device may include: a processor 202, a memory 204, an input/output interface 206, a communication interface 208, and a bus 210. The processor 202, memory 204, input/output interface 206, and communication interface 208 communicate with each other inside the device through the bus 210.

The processor 202 can be implemented using a general-purpose central processing unit (CPU), microprocessor, application-specific integrated circuit (ASIC), or one or more integrated circuits, and is used to execute relevant programs to implement the technical solutions provided by the present disclosure. The processor 202 may also include a graphics card, which can be, for example, an Nvidia Titan X graphics card or a 1080Ti graphics card.

The memory 204 can be implemented in the form of read-only memory (ROM), random access memory (RAM), static storage devices, dynamic storage devices, etc. The memory 204 can store the operating system and other applications. When the technical solutions provided by the present disclosure are implemented through software or firmware, the relevant program codes are stored in memory 204 and are called and executed by processor 202.

The input/output interface 206 is used to connect input/output modules to enable information input and output. The input/output modules can be configured as components within the device (not shown in the figure) or externally connected to the device to provide corresponding functions. The input devices may include a keyboard, mouse, touchscreen, microphone, various sensors, etc., while the output devices may include a display, speakers, vibrators, indicator lights, etc.

The communication interface 208 is used to connect a communication module (not shown in the figure) to enable communication and interaction between this device and other devices. The communication module can establish communication through a wired connection (such as USB, Ethernet, etc.) or through a wireless connection (such as mobile network, WIFI, Bluetooth, etc.).

The bus 210 includes a pathway for transmitting information between the various components of the device (such as processor 202, memory 204, input/output interface 206, and communication interface 208).

It should be noted that although the above device only shows processor 202, memory 204, input/output interface 206, communication interface 208, and bus 210, in practical implementation, the device may also include other components necessary for normal operation. Furthermore, those skilled in the art will understand that the device described above may also only include the components necessary to implement the solutions provided by the present disclosure, without necessarily including all the components shown in the figure.

The present embodiment provides a computer program product, which includes a computer program. When executed by a processor, the computer program implements the method described in any of the embodiments provided in the present disclosure.

The present embodiment also provides a computer-readable storage medium, which stores a computer program. When executed by a processor, the program implements the method described in any of the embodiments provided above.

A computer-readable medium includes both permanent and non-permanent, removable and non-removable media that can be used to store information by any method or technique. The information can be computer-readable instructions, data structures, program modules, or other data. Examples of computer storage media include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory or other memory technologies, CD-ROMs, digital versatile discs (DVDs), or other optical storage, magnetic tape cartridges, magnetic disk storage, or other magnetic storage devices, or any other non-transitory medium that can be used to store information that can be accessed by a computer device. As defined herein, a computer-readable medium does not include transitory computer-readable media, such as modulated data signals and carrier waves.

The various embodiments in the present disclosure are described in a progressive manner. Similar or identical parts between the different embodiments can refer to each other, and each embodiment focuses on the differences from other embodiments. In particular, for the device embodiments, since they are essentially similar to the method embodiments, their descriptions are relatively simple, and the relevant details can be referenced in the method embodiment descriptions. The device embodiments described above are only illustrative, and the modules described as separate components may or may not be physically separate. When implementing the solutions of the present disclosure, the functions of these modules can be realized in the same or a plurality of software and/or hardware. Moreover, some or all of the modules may be selected to achieve the objectives of the present disclosure according to actual needs. Those skilled in the art can understand and implement the solutions without requiring any inventive effort.

The above describes only the specific embodiments of the present disclosure. It should be noted that for those skilled in the art, without departing from the principles of the embodiments of the present disclosure, a plurality of modifications and refinements can be made, and these modifications and refinements should be considered within the scope of protection of the embodiments of the present disclosure.

What is claimed is:

1. A method for training a translation model, the method comprising:
acquiring a first translation loss of the translation model, wherein the first translation loss is positively correlated with a probability that a target output token and a preceding output token of the translation model are the same token, the target output token being the token expected to be output by the translation model when translating a plurality of input tokens included in input information, and the preceding output token being the token obtained by the translation model when translating the plurality of input tokens before obtaining the target output token;
acquiring a first contribution degree of the plurality of input tokens to the target output token and a second contribution degree of the plurality of input tokens to the preceding output token;
adjusting the first translation loss based on a similarity between the first contribution degree and the second contribution degree to obtain a second translation loss of the translation model; and
training the translation model based on the second translation loss.

2. The method according to claim 1, wherein the target output token is a target translation token in reference translation information corresponding to the input information, and the preceding output token is a translation token in the reference translation information located before the target translation token, and the position of the target translation token in the reference translation information corresponds to the position of the target output token in output information, which comprises the target output token and the preceding output token.

3. The method according to claim 2, wherein acquiring the first translation loss of the translation model comprises:
acquiring a first probability that the translation model determines the preceding output token as the target output token, and a second probability that the translation model determines the target translation token as the target output token;
determining the first translation loss of the translation model based on a difference between the first probability and the second probability.

4. The method according to claim 1, wherein a number of preceding output tokens is greater than 1; the first translation loss of the translation model comprises a plurality of translation losses corresponding to the respective preceding output tokens, and the translation loss corresponding to a preceding output token is positively correlated with the probability that the translation model determines that preceding output token as the target output token; the second contribution degree of the plurality of input tokens to the preceding output token comprises the contribution degree of the plurality of input tokens to the plurality of preceding output tokens, respectively;
wherein adjusting the first translation loss based on the similarity between the first contribution degree and the second contribution degree to obtain the second translation loss of the translation model comprises:
for any one preceding output token of the plurality of preceding output tokens, adjusting the translation loss corresponding to the preceding output token based on the similarity between the first contribution degree and the contribution degree of the plurality of input tokens to the preceding output token, to obtain the translation loss corresponding to the preceding output token;
summing the translation losses corresponding to the plurality of preceding output tokens to obtain the second translation loss of the translation model.

5. The method according to claim 1, wherein a distance between the preceding output token and the target output token is less than or equal to a preset distance threshold.

6. The method according to claim 1, wherein adjusting the first translation loss based on the similarity between the first contribution degree and the second contribution degree to obtain the second translation loss of the translation model comprises:
adjusting the first translation loss based on the similarity between the first contribution degree and the second contribution degree to obtain an intermediate translation loss of the translation model;
adjusting the intermediate translation loss based on a distance between the target output token and the preceding output token to obtain the second translation loss of the translation model.

7. The method according to claim 6, wherein adjusting the first translation loss based on the similarity between the first contribution degree and the second contribution degree to obtain the intermediate translation loss of the translation model comprises:
weighting the first translation loss based on the similarity between the first contribution degree and the second contribution degree to obtain the intermediate translation loss of the translation model.

8. The method according to claim 7, wherein the method further comprises:
determining a first attention matrix based on the first contribution degree;
determining a second attention matrix based on the second contribution degree;
acquiring the similarity between the first attention matrix and the second attention matrix, and determining the similarity between the first attention matrix and the second attention matrix as the similarity between the first contribution degree and the second contribution degree.

9. The method according to claim 6, wherein adjusting the intermediate translation loss based on the distance between the target output token and the preceding output token to obtain the second translation loss of the translation model comprises:
weighting the intermediate translation loss based on the distance between the target output token and the preceding output token to obtain the second translation loss of the translation model.

10. The method according to claim 9, wherein weighting the intermediate translation loss based on the distance between the target output token and the preceding output token to obtain the second translation loss of the translation model comprises:
performing an exponential operation on the distance between the target output token and the preceding output token to obtain the weight corresponding to the intermediate translation loss;
weighting the intermediate translation loss based on the weight corresponding to the intermediate translation loss to obtain the second translation loss of the translation model.

11. The method according to claim 1, wherein the plurality of input tokens are extracted from sample product information, the sample product information is obtained from an e-commerce platform, and the sample product information comprises at least two identical terms.

12. A method for translating product information, the method comprising:
acquiring target product information from an e-commerce platform;
acquiring translated product information obtained by translating the target product information using a translation model, wherein the translated product information and the target product information are in different languages;
wherein the translation model is trained based on the method of claim 1.

13. A non-transitory computer-readable storage medium configured with instructions executable by one or more processors to cause the one or more processors to perform operations comprising:
acquiring a first translation loss of a translation model, wherein the first translation loss is positively correlated with a probability that a target output token and a preceding output token of the translation model are the same token, the target output token being the token expected to be output by the translation model when translating a plurality of input tokens included in input information, and the preceding output token being the token obtained by the translation model when translating the plurality of input tokens before obtaining the target output token;
acquiring a first contribution degree of the plurality of input tokens to the target output token and a second contribution degree of the plurality of input tokens to the preceding output token;
adjusting the first translation loss based on a similarity between the first contribution degree and the second contribution degree to obtain a second translation loss of the translation model; and
training the translation model based on the second translation loss.

14. The storage medium according to claim 13, wherein the target output token is a target translation token in reference translation information corresponding to the input information, and the preceding output token is a translation token in the reference translation information located before the target translation token, and the position of the target translation token in the reference translation information corresponds to the position of the target output token in output information, which comprises the target output token and the preceding output token.

15. The storage medium according to claim 14, wherein acquiring the first translation loss of the translation model comprises:
acquiring a first probability that the translation model determines the preceding output token as the target output token, and a second probability that the translation model determines the target translation token as the target output token;
determining the first translation loss of the translation model based on a difference between the first probability and the second probability.

16. The storage medium according to claim 13, wherein a number of preceding output tokens is greater than 1; the first translation loss of the translation model comprises a plurality of translation losses corresponding to the respective preceding output tokens, and the translation loss corresponding to a preceding output token is positively correlated with the probability that the translation model determines that preceding output token as the target output token; the second contribution degree of the plurality of input tokens to the preceding output token comprises the contribution degree of the plurality of input tokens to the plurality of preceding output tokens, respectively;
wherein adjusting the first translation loss based on the similarity between the first contribution degree and the second contribution degree to obtain the second translation loss of the translation model comprises:
for any one preceding output token of the plurality of preceding output tokens, adjusting the translation loss corresponding to the preceding output token based on the similarity between the first contribution degree and the contribution degree of the plurality of input tokens to the preceding output token, to obtain the translation loss corresponding to the preceding output token;
summing the translation losses corresponding to the plurality of preceding output tokens to obtain the second translation loss of the translation model.

17. The storage medium according to claim 13, wherein a distance between the preceding output token and the target output token is less than or equal to a preset distance threshold.

18. The storage medium according to claim 13, wherein adjusting the first translation loss based on the similarity between the first contribution degree and the second contribution degree to obtain the second translation loss of the translation model comprises:
adjusting the first translation loss based on the similarity between the first contribution degree and the second contribution degree to obtain an intermediate translation loss of the translation model;
adjusting the intermediate translation loss based on a distance between the target output token and the preceding output token to obtain the second translation loss of the translation model.

19. The storage medium according to claim 18, wherein adjusting the first translation loss based on the similarity between the first contribution degree and the second contribution degree to obtain the intermediate translation loss of the translation model comprises:
weighting the first translation loss based on the similarity between the first contribution degree and the second contribution degree to obtain the intermediate translation loss of the translation model.

20. An electronic device comprising:
one or more processors; and
one or more computer-readable memories coupled to the one or more processors and having instructions stored thereon that are executable by the one or more processors to perform one or more operations comprising:
acquiring a first translation loss of a translation model, wherein the first translation loss is positively correlated with a probability that a target output token and a preceding output token of the translation model are the same token, the target output token being the token expected to be output by the translation model when translating a plurality of input tokens included in input information, and the preceding output token being the token obtained by the translation model when translating the plurality of input tokens before obtaining the target output token;
acquiring a first contribution degree of the plurality of input tokens to the target output token and a second contribution degree of the plurality of input tokens to the preceding output token;
adjusting the first translation loss based on a similarity between the first contribution degree and the second contribution degree to obtain a second translation loss of the translation model; and
training the translation model based on the second translation loss.
